(19) United States
(12) Patent Application Publication
(10) Pub. No.: US 2007/0080971 A1
(43) Pub. Date: Apr. 12, 2007

(54) Method and apparatus of image buffer compression for display device

(76) Inventor: Chih-Ta Star Sung, Glonn (DE)

Correspondence Address: Chih-Ta Star Sung;RM. 308, BLD.52, NO. 195, CHUNG HSING RD., SEC. 4 CHU TUNG TOWNSHIP, HSINCHU COUNTY, 310, TW

(21) Appl. No.: 11/244,655

(22) Filed: Oct. 6, 2005

(51) Int. Cl. G09G 5/36; G06T 9/00

(52) U.S. Cl. 345/545; 345/555

(57) ABSTRACT

A method and apparatus for reducing the density of a frame buffer image for display device is presented. The source image is compressed before storing into a temporary frame buffer and decompressed before displaying in a display device. When a new object is to be display into the previous frame, the starting and ending position of each line and segment which the new object pixels reside are calculated and the corresponding segments of pixels are decompressed to be concatenated with the new object pixels and re-compressed before storing into the frame buffer.

### BACKGROUND OF THE INVENTION

1. Field of Invention

The present invention relates to image compression/decompression, and more particularly relates to the temporary image compression/decompression for display device which reduces the density requirement of the storage device.

2. Description of Related Art

The sharp quality of Liquid Crystal Display, LCD devices coupled with manufacturing cost reduction in the past years have driven mass production of the LCD related display products in wide applications including display panels of mobile devices like digital TV panel, PC screen panel, portable DVD player, digital still camera (DSC), digital video recorder (DVR), mobile phone, electronic dictionary, telephony panel, video phone, . . . etc.

As shown in FIG. 1, most display systems are comprised of the three main devices: display timing controller 11 and display driver 12 which in many of the latest designs include a frame buffer 13 and a display panel 14. Since display driver, for example, the LCD driver resides a lot of MOS transistors which need to conduct relatively high voltages compared to common used power supply voltage (ex. 3.3V in 0.35 um process) of MOS process, to avoid device breakdown effect, the channel length of the drivers are much longer than regular MOS devices hence dominate large die area. In multimedia era, larger and larger image are integrated into the frame buffer which is commonly comprised of SRAM memory array within a display driver which makes the die area of a display driver even larger. The larger the die area, the lower the yield a chip can obtain and the higher power it will consume.

Therefore, it is beneficial to reduce the required amount of storage devices of the on-chip reference frame buffer to further reduce the cost and power consumption.

### SUMMARY OF THE INVENTION

The present invention is related to a method and apparatus of the frame buffer image compression for display device, which plays an important role in significantly reducing the required storage device density.

The present invention of the frame buffer image compression includes procedures and apparatus of compressing the frame buffer image and saved in a storage device and decompressing the frame buffer image data and sending the recovered image to the display drivers to be displayed.

According to an embodiment of the present invention of the frame buffer image compression, when a new object is to be inserted into the existing frame of image to be displayed, the starting and ending position of each line of new object will be calculated and the corresponding segment of the existing image is identified and recovered to be raw data to let the pixels of new object insert to the right position and re-compress the concatenated pixels.

According to an embodiment of the present invention of the frame buffer image compression, a part of an image is compressed and saved into the frame buffer which reduces the requirement of density significantly.

According to an embodiment of the present invention of the frame buffer image compression, when a new object is sending to the frame buffer, the engine with higher speed clock rate is turned on to decode the corresponding segment with the new object, concatenating the new pixels and re-compress the corresponding segments.

According to an embodiment of the VLC coding algorithm of this invention of frame buffer image compression, only the “Quotient” and “Remainder” are coded with the “Divider” implicitly done by prediction.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of a display system having a driver with a frame buffer comprising of an SRAM.

FIG. 2 illustrates a prior art of a driver chip with a large frame buffer, source drivers and gate drivers.

FIG. 3 depicts the block diagram of the present invention of the display driver chip of source drivers, gate drivers plus a frame buffer with image compression and decompression.

FIG. 4 depicts a method of compression with half line of pixels as a compression unit.

FIG. 5 depicts a method of compression with a segment of pixels as a compression unit.

FIG. 6 illustrates a case of inserting a new object into a frame of image including the description of beginning and ending point of the new object.

FIG. 7 illustrates the combined image of inserting a new object into a frame of image.

FIG. 8 depicts the procedure of inserting a new object into a frame of image.

FIG. 9 depicts the procedure of details of inserting a new object into an existing line of image.

FIG. 10 illustrates the block diagram of the implementation of inserting a new object into an existing frame of image to be displayed.

FIG. 11 illustrates the apparatus of applying even smaller frame buffer to store a partial of an image.

### DESCRIPTION OF THE PREFERRED EMBODIMENTS

The LCD related display device has wide applications including display panels of mobile devices like digital TV panel, PC screen panel, portable DVD player, digital still camera (DSC), digital video recorder (DVR), mobile phone, electronic dictionary, telephony panel, video phone, . . . etc.

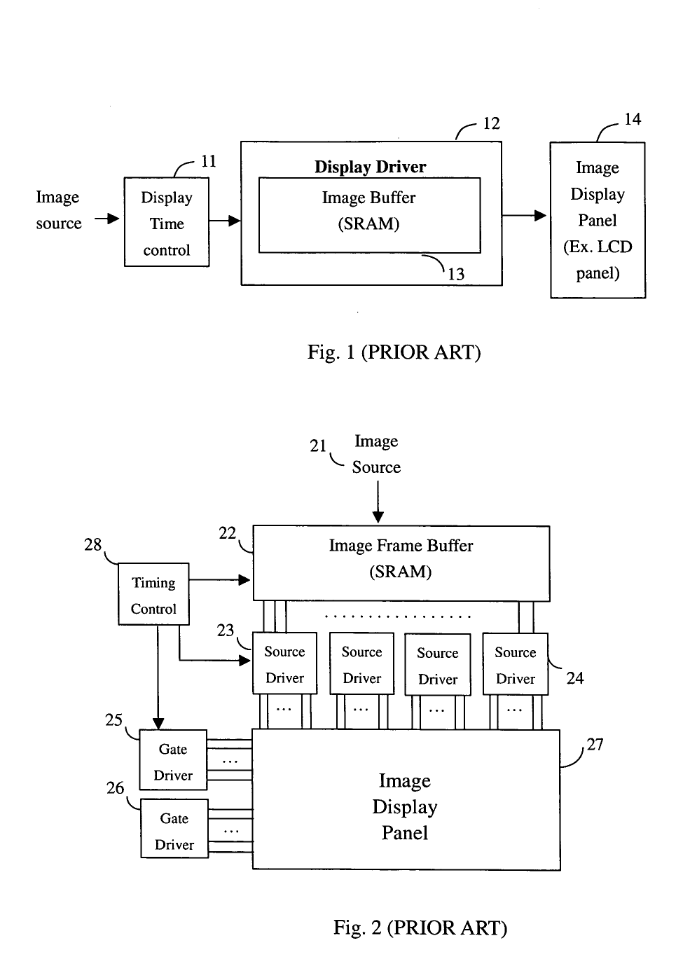

A display system, said an LCD panel, is like a traditional TV with the image displayed line by line sequentially. Most prior art display systems are comprised of the three main devices as shown in FIG. 1: the display timing controller 11 and display driver 12 which in many of the latest designs include a frame buffer 13 and a display panel 14.

FIG. 2 depicts a prior art of display device driver, said LCD driver chip which comprised a timing control unit, a frame buffer, some source drivers and gate drivers. An image source 21 is received and temporarily saved in a frame buffer 22. In an SoC (System On Chip) high integration chip design, the frame buffer is comprised of SRAM (Static Random Access Memory) array for quick accessing. The timing control unit 28 calculates the time to display each line of pixels and controls pixels to drive out to be displayed. The gate drivers 25, 26 comprising some decoders which decide the row number of display. The gate driver is similar to the row driver in a memory array which selects the row number to be accessed in a memory array. Most likely the display starts from selecting the gate driver from top row down to bottom row sequentially. The source drivers 23, 24 drive out the pixels with each pixel column comprising three elements, said Red, Green and Blue to the display panel, for example, an LCD display panel. Therefore, the image to be displayed is saved in a frame buffer and to wait till the right time to start driving out line by line through the source drivers with the line (row) controlled by the gate drivers. For easy in design and control, the frame buffer saves a whole frame of image.

The larger the display screen (panel) the larger frame buffer will be required to save the data of pixels. In larger image size or display panel applications, this invention of frame buffer compression gains higher efficiency in data reduction. For instance, the mobile phone with color display of 128×128 size of display needs about 200K bits SRAM with 6-6-6 bits of R,G,B elements which dominates about 25% of die area of an LCD driver chip, while in 320×240 display resolution, the SRAM size of frame increases to 1.0M bits which dominates about 60% of an LCD driver chip with 0.25 um high voltage CMOS process.

This invention said frame buffer compression of pixel data reduces die area ranging from ˜15% to 30% depending on the resolution. Reducing the density of frame buffer and die area gains another benefit of lower power consumption since power consumption is linearly proportional to the capacitance loading.

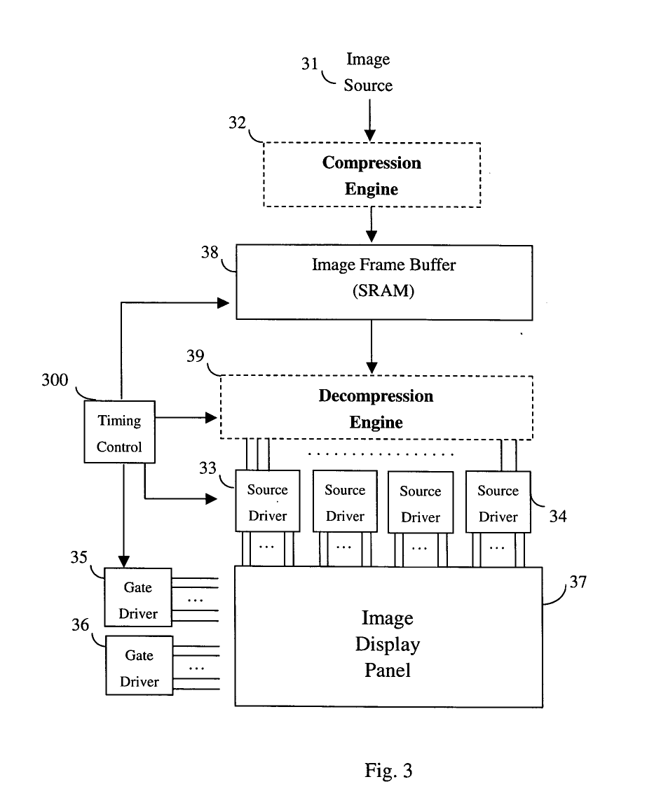

FIG. 3 illustrates the block diagram of this invention of the frame buffer compression of the frame buffer for display device. An image source 31 is sent to be displayed will be firstly compressed by a compression engine 32 before temporarily saving to the frame buffer 38 which most likely an SRAM memory array. When the timing of display reached, the corresponding line of pixels will be recovered by the decompression engine 39 and feed to the source drivers 33, 34 to be display onto the display panel 37. The gate drivers decide the row number for those corresponding row of pixels to be displayed on the display panel. A timing control unit 300 calculates the right timing of displaying the right line of pixels stored in the frame buffer, sends signal to the frame buffer and the decompression engine to inform the status of display. For instance, send an “H-Sync” signal to represent a new line needs to be display within a certain time slot. When the decompression engine receives this signal, it starts accessing the frame buffer and decompressing the compressed pixel data and recovers the whole line of pixels and send them to the source driver unit for display.

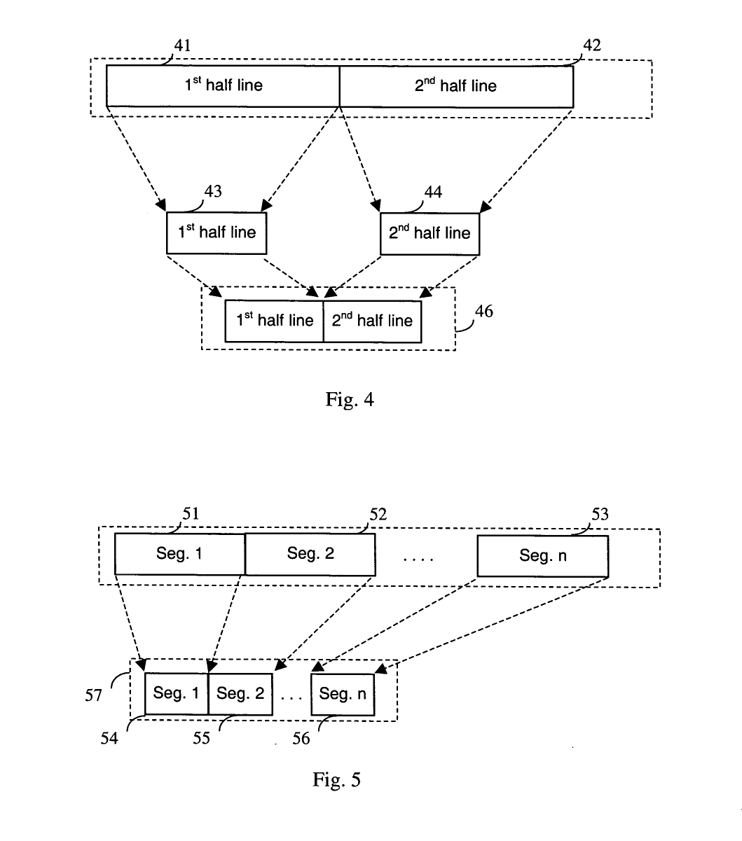

The compression and decompression engine of this invention of the frame buffer compression of the frame buffer for display device adopts a whole frame of image pixels as a compression unit, also adopts a line of image pixels and a segment of image pixels as a unit of compression. When a frame pixels are defined as the group of compression unit, a predetermined compression rate, for example, said 2.0×is reached of reducing the frame data rate by a factor of 2.0. When a half line of pixels is selected as a group of pixels of compression unit as shown in FIG. 4, the 1^{st} half line 41 of pixels is compressed independently from the 2^{nd} half line of pixels 42. The compressed 1^{st} half line 43 and the compressed 2^{nd} half line 44 are concatenated to form a compressed line 45 which is 50% length of the original uncompressed line. The two half lines of compression can be done in parallel or in series. In compressing in parallel, the original image should have a whole line of pixels ready. FIG. 5 depicts another mechanism of this invention of the frame buffer compression of the frame buffer for display device which uses smaller number of pixels as a compression unit called “segment”. A segment represent a group of pixels of a certain length of pixels, for example, said ¼ or ⅛ of a line pixels. Segment 1, said Seg.1, Seg. 2 to Seg. n 51, 52, 53 are compressed independently and result in the compressed segments 54, 55, 56 which together form a line of compressed pixels. A whole frame buffer of pixel can be compressed line by line with fixed compressed rate of each line or variable compression rate from line to line and reaches a final fixed compress rate of a whole frame.

In some applications, there will be a new object being displayed together with last image in the frame buffer. For instance, a frame buffer storing an image of Mr. Mickey, a new object of a peanut might be sent to shown on his mouse. In this case, the display panel still keeps displaying the original frame buffer content of Mr. Mickey and will add new object of a peanut from a corresponding location.

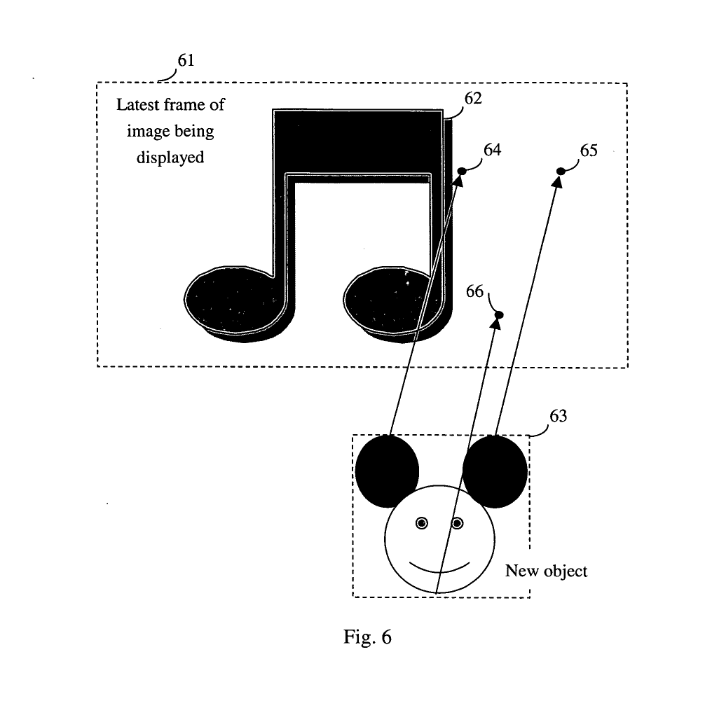

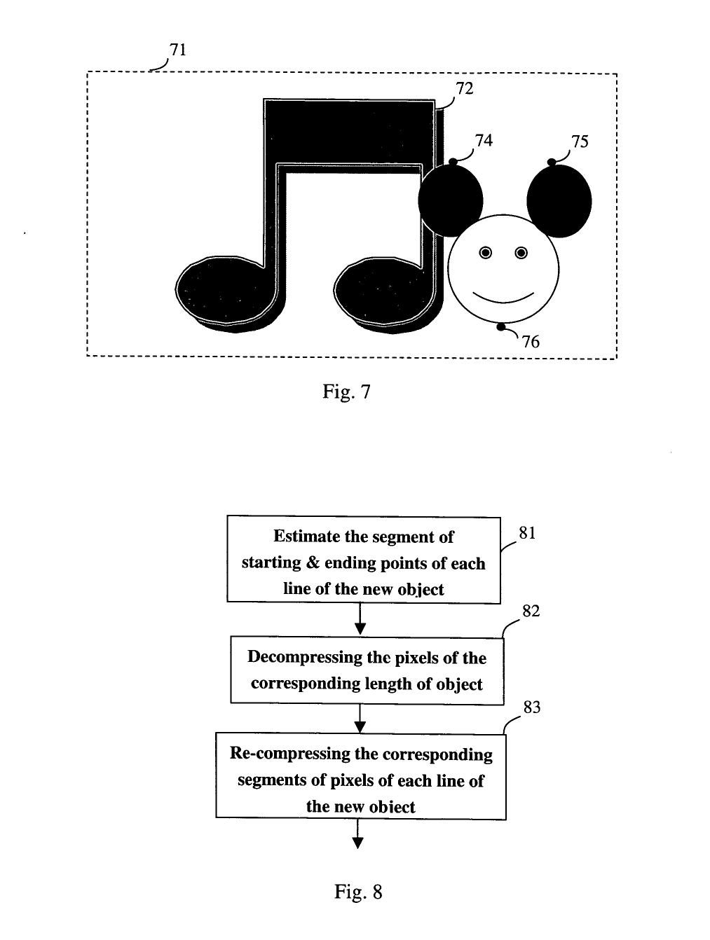

This invention of the frame buffer compression of the frame buffer for display device manipulates this kind of situation by combining the latest frame of image and the new object as shown in FIG. 6. The latest frame 61 of image 62 being displayed is saved into a frame buffer. The new object 63 with description of the starting 64 and ending 65 positions of each line of pixels. The position of the last pixel 66 will also be clearly identified. The combined frame 71 of image will be looked like that shown in FIG. 7. All image pixels of the new object is inserted to the side of the original object 72 with the corresponding position including the starting, 74, and ending point, 75, of a line and the last pixel 76.

FIG. 8 briefly illustrates the procedure of combining the new object into the latest frame of image. Once the starting point and ending point of each line of the new object is identified, the corresponding segment of each line is calculated 81. Then, the decompression unit recovers 82 the compressed segment of pixels to the position of the end of the new object of each line, and compressed then concatenates the combined pixel, then saves the re-compressed line into the frame buffer for future use.

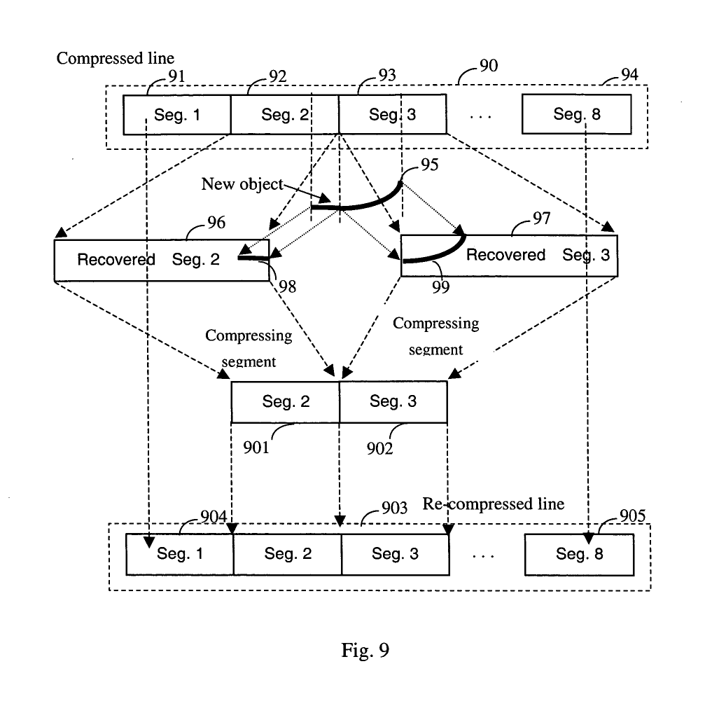

FIG. 9 illustrates details of an example of asserting an new object into a frame of image and how this invention of frame buffer compression for the display device operates on this situation. A new object 95 is to be inserted into a line 90 of pixels comprising several of segments 91, 92, 93, 94 of image data of an existing frame which has been compressed and stored in a storage device. The 1^{st} step is to calculate the staring and ending position of the new object in which falls into this line and identifying the corresponding segments of pixels which the new object to be combined. In this example, the new object will be laid across Seg. 2 (Segment 2) and Seg. 3. And the next step is to decompress the Seg. 2 and Seg. 3 till the corresponding position of the new object pixels starts. Then, the part of the new object 98 belonging to Seg. 2 concatenates with the recovered pixels of Seg. 2 and form an updated new 96 Seg. 2. and the part of the new object 99 belonging to Seg. 3 concatenates with the recovered pixels of Seg. 3 and form an updated new 97 Seg. 3. Afterward, re-compressing 901, 902 the updated Seg. 2 and updated Seg. 3. Other segments 904, 905 with compressed pixels which don't include any pixel of the new object are copied and concatenated with Seg.2 and Seg. 3 result in a complete line 903 of compressed pixels.

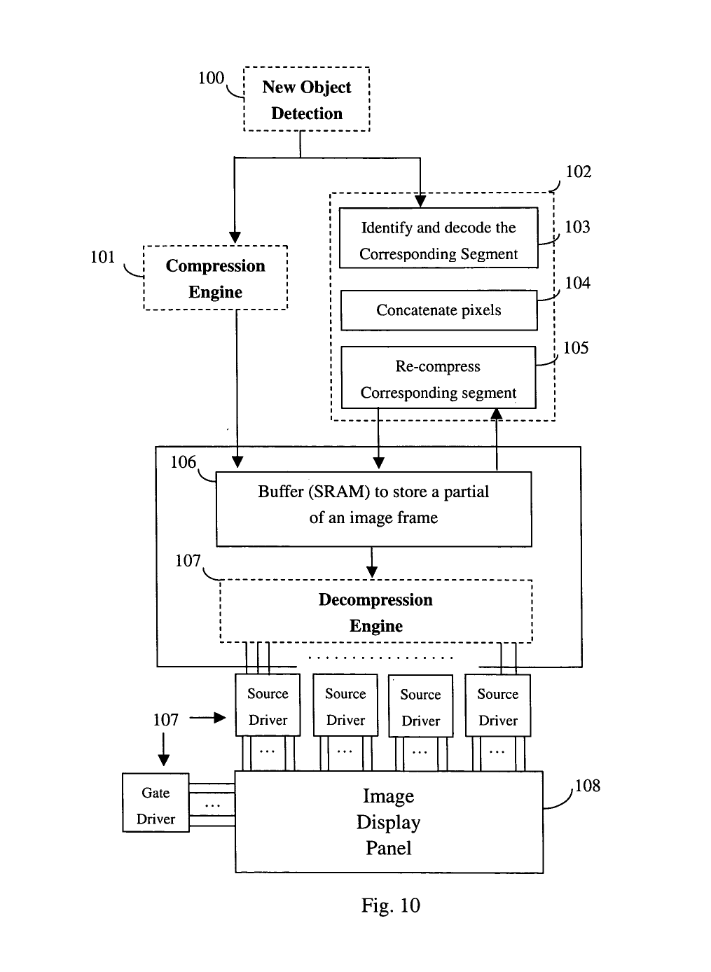

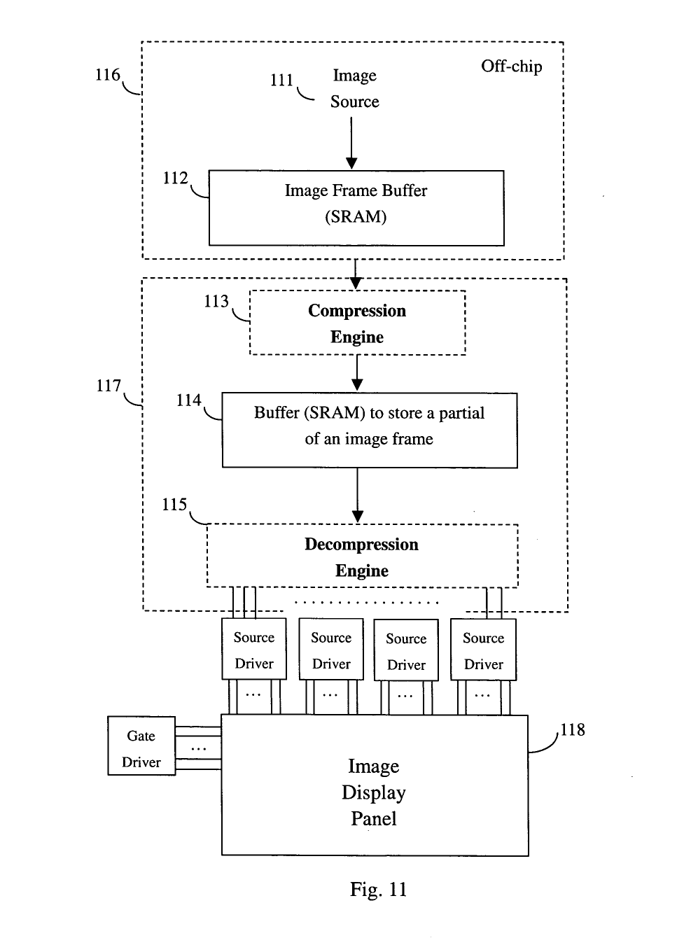

FIG. 10 shows the block diagram of the implementation of this invention of compressing the image frame buffer with new object to be displayed on top of existing image. If the coming pixels are within a complete frame, the image will be compressed through a compression engine 101 which has most likely slower speed of clock rate. A coming image is detected to tell whether this is a new object 100 to be overlapped on top of the present image and displayed jointly. Most lines of pixels within a new object have either starting and ending or both address in the display frame buffer different from previously displayed image. As described in above paragraph of the method of inserting a new object into the present frame to be displayed, the corresponding segment 103 of previously compressed pixels will be recovered by extracting from the frame buffer 106. The recovered corresponding segment of pixels will then be concatenated 104 with the new object to be inserted and re-compressed 105. The re-compressed segments will be concatenated with those previously compressed segment and stored into the frame buffer. The combined and compressed image frame saved in the frame buffer will be decompressed 107 and sent to the display device under the right timing. Since inserting a new object into the existing frame buffer requires more procedure including identifying the corresponding segments of new pixels fall into, decoding the corresponding segments and re-compressing the concatenated segments, using higher speed of the clock rate of engines manipulating these functions helps in gaining higher performance.

Further reducing the density of the frame buffer size of the display device is feasible by applying smaller frame buffer size to store only a partial of an image. For example, the image source 111 might reside in another device 116, a storage device 112 or internet/networking device or a subsystem. A partial (a half, a quarter or smaller part) frame 114 of an image is to be temporarily stored in a image buffer within an LCD display driver. The compression engine 113 compresses the coming pixels and stored into the temporary image buffer 114. Another unit of decompression engine 115 recovers the compressed pixels accessed from the temporary image buffer 114 and sends to the source drivers to be displayed in the display panel 118. In mobile devices like mobile phone, digital camera, digital camcorder . . . there is DRAM to be used as temporary buffer which is a candidate of storing the source image to be displayed in the display panel. If the display driver has an embedded function of converting YIUN or Y/Cr/Cb to R, G, B, then this invention can also be applied to compress the image source of YIUN or Y/Cr/Cb with similar procedure as described above.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of frame buffer image compression and decompression for display device, comprising:
compressing a group of pixels of the image source;
saving the compressed group of pixels into a first temporary storage device;
before displaying, decompressing a group of compressed pixels of the compressed data; and
sending the decompressed pixels to a second temporary storage device for driving out to a display device.

2. The method of claim 1, wherein the image source is comprised of at least one of Red, Green, Blue color element.

3. The method of claim 1, wherein the image source is comprised of at least one of Y, Cr, Cb or Y, U, V element.

4. The method of claim 1, wherein the group of pixels as a compression unit is a frame of image.

5. The method of claim 1, wherein the group of pixels as a compression unit is a line of pixels.

6. The method of claim 1, wherein the group of pixels as a compression unit is a segment of pixels.

7. The method of claim 1, wherein the decompressed group of pixels are sent out to let the source drivers drive the corresponding color elements to the display device.

8. The method of claim 1, wherein a source driver drives three color elements out to the display device.

9. A method of frame buffer image compression for display device, when a new object of an image is sent to be displayed together with previous frame of image, this method efficiently reduces the density of storage device and bandwidth requirement of transmitting by procedures, comprising
calculating the starting and ending points of each line of pixels of the new object;
decompressing the corresponding segment of pixels of each line of the latest image saved in the frame buffer on which the pixels of the new object will reside;
Concatenating pixels of the decompressed image and the new object of pixels within corresponding segments which have pixels of new object; and
re-compressing the corresponding segment of pixels of each line of the existing image on which the pixels of the new object will reside;

10. The method of claim 9, wherein a new object is comprised of a group of pixels.

11. The method of claim 10, wherein a group of pixels of the new object is comprised of pixels distributed in at least one line or one segment.

12. The method of claim 9, wherein when decompressing the corresponding segment of pixels, the procedure ends in the pixel where the new object starts and the rest of pixel till the end of a segment are replaced by pixels of the new object.

13. The method of claim 9, wherein when decompressing the corresponding segment of pixels, the pixels of the new object which fall on the beginning of a new segment replace pixels of the decompressed pixels in the former section of a segment.

14. The method of claim 9, wherein the segments with no new object residing will be left compressed format.

15. An apparatus of frame buffer image compression and decompression for display device, comprising:
a compression engine with a first speed of clock rate which takes a group of pixels of the image source and compresses into a smaller amount of pixel data;
a timing control unit which determines the timing of driving out the corresponding pixels onto the display device;
another compression and decompression engine with a second speed of clock rate to recover the existing segment pixels and merging new object pixels to form a new line and re-compress the new line and save it back to the frame buffer;
a decompression engine which recovers a group of pixels of stored in the frame buffer to be driven out to the display device;
gate driver circuit which select the row of display pixels; and
source driver circuit with each pixels having Red, Green and Blue element to be sent out to be displayed.

16. The apparatus of claim 15, wherein the timing control unit calculates the timing of driving out the corresponding pixels color elements of each row by sending signal to the gate drive, the source driver and the frame buffer of image regarding the right timing and location of frame pixels to be displayed.

17. The apparatus of claim 15, wherein at least one temporary segment pixel buffer is implemented for intermediately saving the decompressed pixels of corresponding segments.

18. The apparatus of claim 15, wherein the compression engine is used to compress the decompressed and concatenated segment of pixels with new object.
